(19) United States
(12) Patent Application Publication
(10) Pub. No.: US 2025/0089957 A1
(43) Pub. Date: Mar. 20, 2025

(54) VACUUM CLEANER

(71) Applicant: MANN+HUMMEL LIFE SCIENCES & ENVIRONMENT HOLDING SINGAPORE PTE. LTD., Singapore (SG)

(72) Inventors: Daniel FORBERG, Neuenmarkt (DE); Christopher JEBLICK, Schifferstadt (DE)

(21) Appl. No.: 18/823,642

(22) Filed: Sep. 3, 2024

(30) Foreign Application Priority Data
Sep. 14, 2023 (DE) 102023124848.0

(51) Int. Cl. A47L 7/00; A47L 9/12; A47L 9/24; B01D 53/04; B01J 20/20; B01J 20/28

(52) U.S. Cl. CPC A47L 7/0085; A47L 9/12; A47L 9/248; B01D 53/0407; B01J 20/20; B01J 20/28045; B01D 2253/102; B01D 2253/3425; B01D 2257/302; B01D 2257/404; B01D 2257/708; B01D 2257/90; B01D 2258/06; B01D 2259/40088

(57) ABSTRACT

The present invention provides a vacuum cleaner for cleaning a surface, wherein the vacuum cleaner comprises: a suction mouth for bearing against the surface; a chamber for receiving particulate material entering the vacuum cleaner through the suction mouth; a suction device for providing an air flow into the suction mouth; and a conduit connecting the suction mouth to the chamber, wherein the conduit comprises an adsorbent in the form of a honeycomb having a plurality of channels that are separated from each other by channel walls, and wherein the honeycomb adsorbent comprises activated carbon. There is also provided the use of an adsorbent in the form of a honeycomb in a conduit of the vacuum cleaner.

### CROSS-REFERENCE TO RELATED APPLICATIONS

This application claims the benefit of German patent application No. 10 2023 124 848.0 filed on Sep. 14, 2023, the entire disclosure of which is incorporated herein by way of reference.

### TECHNICAL FIELD

The invention relates to appliances for cleaning an indoor environment, in particular a vacuum cleaner, comprising adsorbent in the form of a honeycomb. The invention also relates to the use of an adsorbent in the form of a honeycomb in such appliances.

### BACKGROUND ART

Environments, in particular the air of an indoor environment, may have unpleasant odors that cleaning appliances can be designed to remove. Additionally, undesirable particles removed by cleaning appliances may accumulate within the appliance, causing unpleasant odors to be generated and/or built up therein. Adsorbents may be incorporated into cleaning appliances to remove such odors.

While it is known to incorporate adsorbents into cleaning appliances to remove odors, there is a need to provide alternative solutions that overcome, or at least ameliorate, the problem(s) described above and other disadvantages.

### SUMMARY

In an aspect, there is provided a vacuum cleaner for cleaning a surface, wherein the vacuum cleaner comprises: a suction mouth for bearing against the surface; a chamber for receiving particulate material entering the vacuum cleaner through the suction mouth; a suction device for providing an air flow into the suction mouth; and a conduit connecting the suction mouth to the chamber, wherein the conduit comprises an adsorbent in the form of a honeycomb having a plurality of channels that are separated from each other by channel walls, and wherein the honeycomb adsorbent comprises activated carbon.

Advantageously, unpleasant odors may be removed as soon as air is sucked into the disclosed vacuum cleaner. Further advantageously, the particulate material that accumulate in the chamber may be stripped of or have a reduced concentration of undesirable odors and/or harmful contaminants like volatile organic compounds, oxides of nitrogen, sulfur oxides, and formaldehyde. Yet further advantageously, due to the monolithic structure of the honeycomb adsorbent, the honeycomb adsorbent may be treated, e.g., heated, to release molecules adsorbed on its surface, thereby providing a regenerable filter element.

In another aspect, there is provided the use of an adsorbent in the form of a honeycomb in a conduit of a vacuum cleaner, wherein the conduit connects a suction mouth to a chamber for receiving particulate material entering the vacuum cleaner through the suction mouth, wherein the honeycomb adsorbent has a plurality of channels that are separated from each other by channel walls, and wherein the honeycomb adsorbent comprises activated carbon.

### BRIEF DESCRIPTION OF DRAWINGS

The drawings show:

FIG. 1 which illustrates a vacuum cleaner 100 according to an embodiment of the invention.

FIG. 2 which illustrates a vacuum cleaner 100′ according to another embodiment of the invention.

FIG. 3 which illustrates a honeycomb 200 according to an embodiment of the invention.

### DETAILED DESCRIPTION

Cleaning appliances that incorporate activated carbon adsorbents may include vacuum cleaners, dust collectors, and indoor and outdoor air filter systems or air purifiers that remove dust, dirt and other particulate materials from a gaseous or contaminated air stream.

Activated carbon, also known as active carbon or charcoal, may come in many forms. The form of activated carbon used may depend on the requirements and/or the appliance it is used in.

Activated carbon may be in the form of a honeycomb as disclosed herein, and thus is termed “honeycomb adsorbent” herein.

Activated carbon in particulate form includes powdered activated carbon and granulated activated carbon. Particulate activated carbon may be used as packed beds or loose fills in a housing, container or bag.

Activated carbon may be incorporated into filtration media. The activated carbon may be attached, coated, impregnated or otherwise immobilized onto fabric, fleece or other types of fibers. Indoor air purifiers may include filtration media comprising a plurality of layers, wherein one of the layers is an activated carbon layer. The filtration media may be pleated to increase surface area. Alternatively or additionally, where the flow of air through an indoor air purifier is directed through a conduit, for example at an air outlet pipe, activated carbon in the form of a honeycomb as disclosed herein may be included in the conduit.

For vacuum cleaners, a suitable conduit to arrange a honeycomb adsorbent therein includes the conduit connecting the suction mouth of the vacuum cleaner to a chamber for receiving particulate material comprised in air drawn into the vacuum cleaner via the suction mouth.

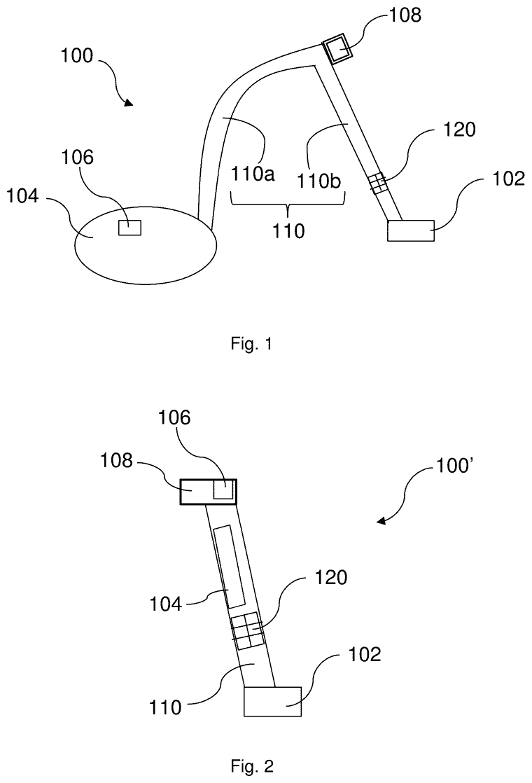

FIGS. 1 and 2 illustrate vacuum cleaners according to embodiments of the invention. FIG. 1 illustrates a conventional vacuum cleaner 100 in which the vacuum cleaner is powered by a plug (not shown) connected to a power source. FIG. 2 illustrates a cordless vacuum cleaner 100′ powered by a battery (not shown) comprised in the vacuum cleaner 100′. Cordless vacuum cleaners are also known as stick vacuum cleaners. The vacuum cleaner 100, 100′ comprises a suction mouth 102 that extends along a direction of the surface to be cleaned, thereby being capable of bearing against the surface. The vacuum cleaner 100, 100′ further comprises a chamber 104 for receiving particulate material entering the vacuum cleaner 100, 100′ through the suction mouth 102. The chamber 104 may be arranged at an end of conduit 110 opposite the end of the conduit 110 connected to the suction mouth 102, as shown in FIG. 1. The chamber 104 may be arranged at other suitable regions of a vacuum cleaner, such as within conduit 110 of vacuum cleaner 100′, as shown in FIG. 2. The vacuum cleaner 100, 100′ further comprises a suction device 106 for providing an air flow into the suction mouth 102. The suction device 106 may be comprised in the chamber 104, as shown in FIG. 1, or may be comprised in other suitable regions of a vacuum cleaner, such as a handle 108 as shown in FIG. 2. The suction device 106 typically comprises a fan (not shown) that generates a vacuum to draw air in from an environment into the vacuum cleaner 100, 100′ through the suction mouth 102. The environment may include air in the region of a surface to be cleaned. The air may comprise particulate material to be removed, including, but not limited to, dust, dirt, liquid or liquid droplets entrained in the air, broken pieces of objects and insects. The particulate material may be resting on the surface or comprised in the air around the surface. The particulate material comprised in the air entering the vacuum cleaner 100, 100′ may be separated by a bag or centrifugal separator (not shown) and the separated particulate material is received in the chamber 104. Exhaust air comprising little or substantially no particulate material may exit the vacuum cleaner 100, 100′ via an air outlet (not shown).

The flow path within the vacuum cleaner 100, 100′ starts from the suction mouth 102 and ends at the air outlet. The chamber 104 is provided downstream, in terms of flow, of the separator in order to receive the particulate material separated by the separator. Between the suction mouth 102 and the chamber 104, a conduit 110 is provided and provides a flow path for the air therebetween. The conduit 110 may be rigid or flexible or a combination of both. For example, the vacuum cleaner 100 of FIG. 1 comprises a rigid portion 110b and a flexible portion 110a for ease of maneuverability, while the conduit 110 of vacuum cleaner 100′ illustrated in FIG. 2 is rigid.

The conduit 110 comprises adsorbent in the form of a honeycomb 120. The honeycomb adsorbent 120 may be arranged within any part of a conduit as disclosed herein. In some embodiments, the honeycomb adsorbent is arranged in a rigid portion of the conduit. Alternatively or additionally, the honeycomb adsorbent may be comprised in the chamber or air outlet. Alternatively or additionally, adsorbent in other forms may be incorporated into a vacuum cleaner or other cleaning appliances. For example, particulate activated carbon may be provided in a porous bag in a chamber of the vacuum cleaner.

The honeycomb adsorbent may be arranged downstream of the suction mouth 102, in terms of flow. The honeycomb adsorbent may be arranged upstream of the chamber 104 and/or upstream of the suction device 106 and/or upstream of the separator. Where the chamber 104 is arranged within conduit 110, the honeycomb adsorbent may be arranged downstream of the chamber 104 and upstream of the suction device 106.

The adsorbent may comprise adsorbent compounds other than activated carbon, such as other physisorbers and/or chemisorbents, as long as a honeycomb structure is maintained. Other adsorbent compounds may be included depending on the environment to be cleaned what compounds are required to be adsorbed. Examples of other physisorbers and chemisorbents that can be included are silica gel, activated alumina, molecular sieves, drying agents such as clays, calcium carbonate, calcium sulfate, potassium permanganate, potassium carbonate, phosphoric acid, or citric acid. The adsorbent, e.g., the honeycomb adsorbent, may be chemically modified to improve adsorption efficiency towards the compounds required to be adsorbed. Chemical modifications may include coating, impregnation, treatment, or other suitable types of modifications, for example, with acids, bases, metal salts, or organic amines.

The adsorbent may be extruded into the honeycomb structure. The honeycomb adsorbent may be an extruded article. The adsorbent may be a shaped monolithic article having a honeycomb structure. An extrudable composition including carbon particles from a carbon precursor may be extruded to result in the honeycomb structure. Alternatively, the extruded article may include adsorbents, such as clay, with activated carbon and/or other adsorbents coated on the extruded article.

The activated carbon may be derived from a carbon precursor. The carbon precursor may be selected from the group consisting of wood, wood dust, wood flour, cotton linters, peat, coal, lignite, petroleum pitch, petroleum coke, coal tar pitch, carbohydrates, coconut shell, fruit pits, fruit stones, nut shells, nut pits, sawdust, palm, vegetables, synthetic polymer, natural polymer, cellulosic material, lignocellulosic material, and combinations thereof.

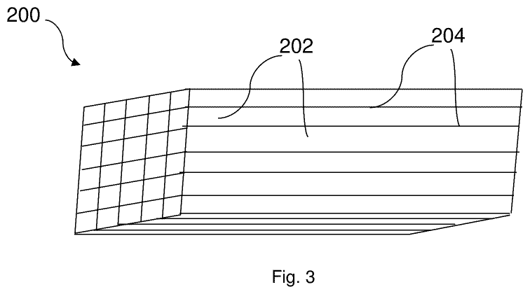

The structure of the honeycomb disclosed herein is illustrated in FIG. 3. FIG. 3 illustrates a honeycomb 200 according to an embodiment of the invention. The honeycomb 200 comprises a plurality of channels 202 that are separated from each other by channel walls 204. The plurality of channels 202 may extend substantially parallel to each other.

The outer shape or overall shape of the honeycomb 200 is shown in FIG. 3 to be a quadrilateral. In other embodiments, the shape of the honeycomb 200 may be any suitable shape. In some embodiments, the honeycomb adsorbent has a shape that corresponds to the appliance it is arranged in. In some embodiments, the honeycomb adsorbent has a shape that corresponds to an inner volume of a conduit that it is arranged in. The honeycomb 200 may be shaped to fit an inner volume of the conduit 110 of vacuum cleaner 100, 100′. The honeycomb 200 may be shaped such that the channel walls 204 that form the outer shape of the honeycomb 200 abut the inner walls of the conduit, such that air flow is required to go through the honeycomb 200.

The honeycomb adsorbent may be adhered or otherwise attached to the inner walls of the conduit. The honeycomb adsorbent may be housed in a frame that is adhered or otherwise attached to the inner walls of the conduit.

As it is desirable for the pressure drop of the air flow between the suction device and the suction mouth to be as minimal as possible, the honeycomb may advantageously be a flow-through honeycomb. Furthermore, the noise level generated by air flow through a flow-through honeycomb may advantageously be lower than through adsorbents in other forms.

Each channel 202 of the plurality of channels may exhibit a uniform cross section. Suitable cross sections may be selected from a group consisting of trigonal, tetragonal, square, pentagonal, hexagonal, octogonal, spherical, and oval cross-section. Alternatively, it is conceivable that a channel 202 may exhibit a cross section different from another channel 202.

The honeycomb may have a cell density in a range of between 10 cells per square inch and 650 cells per square inch. The cell density may be selected depending on the adsorption efficiency and the pressure drop required.

Channel walls 204 may have a substantially uniform thickness throughout the length of the channel 202. Channel 202 may have a substantially uniform cross-sectional inner diameter throughout its length. Each channel 202 or the plurality of channels 202 may be substantially parallel to the longitudinal axis of the conduit. The air flow travelling through the conduit and into the channels 202 of the honeycomb adsorbent may advantageously not be bent or redirected unnecessarily.

The length of the plurality of channels 202 may be selected depending on the adsorption efficiency and capacity required. For example, the length of the plurality of channels 202 may be selected to maintain sufficient turbulent air flow within the channels 202, so that the air has sufficient contact time with the channel walls 204 comprising the adsorbent.

The vacuum cleaner or other cleaning appliance may further comprise a particulate filter arranged before or upstream of the honeycomb adsorbent, in terms of air flow. The particulate filter may filter away coarse particles or particles with effective dimensions that could plug the channels of the honeycomb adsorbent.

The present disclosure provides for the use of an adsorbent in the form of a honeycomb in a conduit of a vacuum cleaner, wherein the conduit connects a suction mouth to a chamber for receiving particulate material entering the vacuum cleaner through the suction mouth. The adsorbent may be one as disclosed herein. Suitable adsorbents and honeycomb adsorbents are commercially available from MANN+HUMMEL.

1. A vacuum cleaner for cleaning a surface, wherein the vacuum cleaner comprises:
a suction mouth for bearing against the surface;
a chamber for receiving particulate material entering the vacuum cleaner through the suction mouth;
a suction device for providing an air flow into the suction mouth; and
a conduit connecting the suction mouth to the chamber,
wherein the conduit comprises an adsorbent in the form of a honeycomb having a plurality of channels that are separated from each other by channel walls, and wherein the honeycomb adsorbent comprises activated carbon.

2. The vacuum cleaner of claim 1, wherein the plurality of channels extend substantially parallel to each other and are substantially parallel to the longitudinal axis of the conduit.

3. The vacuum cleaner of claim 1, wherein the honeycomb adsorbent has a shape that corresponds to an inner volume of the conduit.

4. The vacuum cleaner of claim 1, wherein the honeycomb is a flow-through honeycomb.

5. The vacuum cleaner of claim 1, wherein the honeycomb has a cell density in a range of between 10 cells per square inch and 650 cells per square inch.

6. The vacuum cleaner of claim 1, wherein the honeycomb adsorbent is an extruded article.

7. The vacuum cleaner of claim 1, wherein the activated carbon is derived from a carbon precursor selected from the group consisting of wood, wood dust, wood flour, cotton linters, peat, coal, lignite, petroleum pitch, petroleum coke, coal tar pitch, carbohydrates, coconut shell, fruit pits, fruit stones, nut shells, nut pits, sawdust, palm, vegetables, synthetic polymer, natural polymer, cellulosic material, lignocellulosic material, and combinations thereof.

8. The vacuum cleaner of claim 1, further comprising a particulate filter arranged before the honeycomb adsorbent in terms of air flow.

9. Use of an adsorbent in the form of a honeycomb in a conduit of a vacuum cleaner,
wherein the conduit connects a suction mouth to a chamber for receiving particulate material entering the vacuum cleaner through the suction mouth,
wherein the honeycomb adsorbent has a plurality of channels that are separated from each other by channel walls, and
wherein the honeycomb adsorbent comprises activated carbon.
